(19) United States
(12) Patent Application Publication
(10) Pub. No.: US 2023/0010648 A1
(43) Pub. Date: Jan. 12, 2023

(54) BUCKLE LOCK ASSEMBLY

(71) Applicant: ABA LOCKS INTERNATIONAL CO., LTD., NEW TAIPEI CITY (TW)

(72) Inventor: MIKO LEE, NEW TAIPEI CITY (TW)

(21) Appl. No.: 17/371,648

(22) Filed: Jul. 9, 2021

(51) Int. Cl. E05B 15/04; E05C 19/12

(52) U.S. Cl. CPC E05B 15/04; E05C 19/12; E05B 2015/0455

(57) ABSTRACT

A buckle lock assembly has a hook unit, a fixing base, a wrench unit, a buckling ring unit, and a lock. The hook unit is adapted to be securely mounted on a first locked unit. The fixing base is adapted to be securely mounted on a second locked unit and has a locking segment. The wrench unit is pivotally mounted on the fixing base. The buckling ring unit is pivotally mounted on the wrench unit and selectively clasps the hook unit. The lock is securely mounted on the wrench unit and has a locked state and an unlocked state. In a locked state, the lock engages with the locking segment to limit the wrench unit pivoting relative to the fixing base. In an unlocked state, the lock disengages from the locking segment to allow the wrench unit to pivot relative to the fixing base.

### BACKGROUND OF THE INVENTION

### 1. Field of the Invention

The present invention relates to a box buckle, especially to a buckle lock assembly that has a lock and a function of locking.

### 2. Description of the Prior Arts

A box buckle is usually applied on a sealing can, a sealing box, or an ordinary can or box, and is mainly used to ensure that the lid or cap is tightly closed.

With reference to FIG. 9, a conventional box buckle has a hook unit 91, a fixing base 92, a wrench unit 93, and a buckling ring unit 94. The hook unit 91 and the fixing base 92 are respectively mounted on a lid and a can body or an annular wall of a box. An end of the wrench unit 93 is pivotally mounted on the fixing base 92. The buckling ring unit 94 is pivotally mounted on the wrench unit 93. For use, a user first moves the wrench unit 93 and the buckling ring unit 94 to hook the buckling ring unit 94 with the hook unit 91. Then, the user wrenches the wrench unit 93 and pushes another end of the wrench unit 93 opposite to the fixing base 92 toward the fixing base 92, and the wrench unit 93 will drive the buckling ring unit 94 to pull the hook unit 91 to tightly close the lid.

However, although the conventional box buckle is capable of tightly closing the lid, anyone can wrench the wrench unit 93 again reversely to unfasten the box buckle, which means the conventional box buckle does not have an anti-theft function.

To overcome the shortcomings, the present invention provides a buckle lock assembly to mitigate or obviate the aforementioned problems.

### SUMMARY OF THE INVENTION

The main objective of the present invention is to provide a buckle lock assembly that can be locked after bucking and tightly closing the cover, so the buckle lock assembly has an anti-theft function. Additionally, a locking structure of the buckle lock assembly is located inside the buckle lock assembly, so the locking structure cannot be broken to unlock from the outside.

The buckle lock assembly is adapted to be mounted on a first locked unit and a second locked unit, and is capable of locking the first locked unit and the second locked unit. The buckle lock assembly has a hook unit, a fixing base, a wrench unit, a buckling ring unit, and a lock. The hook unit is adapted to be securely mounted on the first locked unit. The fixing base is adapted to be securely mounted on the second locked unit and has a locking segment. The wrench unit is pivotally mounted on the fixing base. The buckling ring unit is pivotally mounted on the wrench unit and is selectively clasping the hook unit. The lock is securely mounted on the wrench unit. When the lock is in a locked state, the lock engages with the locking segment of the fixing base to limit the wrench unit pivoting relative to the fixing base to lock the first locked unit and the second locked unit. When the lock is in an unlocked state, the lock disengages from the locking segment of the fixing base to allow the wrench unit to pivot relative to the fixing base.

By securely mounting the lock on the wrench unit and forming the locking segment on the fixing base, after the buckling ring unit clasps the hook unit and is pulled by the wrench unit to buckle, a user can switch the lock to the locked state and make the lock engage with the locking segment of the fixing base to limit the wrench unit pivoting relative to the fixing base again. Eventually, the first locked unit and the second locked unit are locked with each other, and therefore the buckle lock assembly has an anti-theft function.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a buckle lock assembly in accordance with the present invention;

FIGS. 2 and 3 are operational views of the buckle lock assembly in FIG. 1;

FIG. 4 is an exploded view of the buckle lock assembly in FIG. 1;

FIG. 5 is another exploded view of the buckle lock assembly in FIG. 1, showing the wrench unit and the lock;

FIG. 6 is another perspective view of the buckle lock assembly in FIG. 1, shown from behind;

FIGS. 7 and 8 are operational views of the buckle lock assembly in FIG. 1, showing unlocking the buckling unit and the fixing base; and

FIG. 9 is a perspective view of a conventional box buckle.

### DETAILED DESCRIPTION OF THE PREFERRED EMBODIMENTS

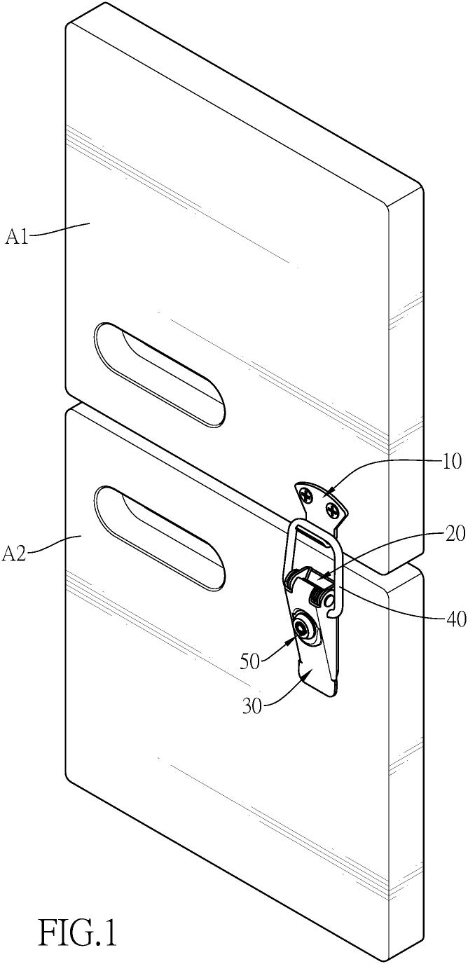

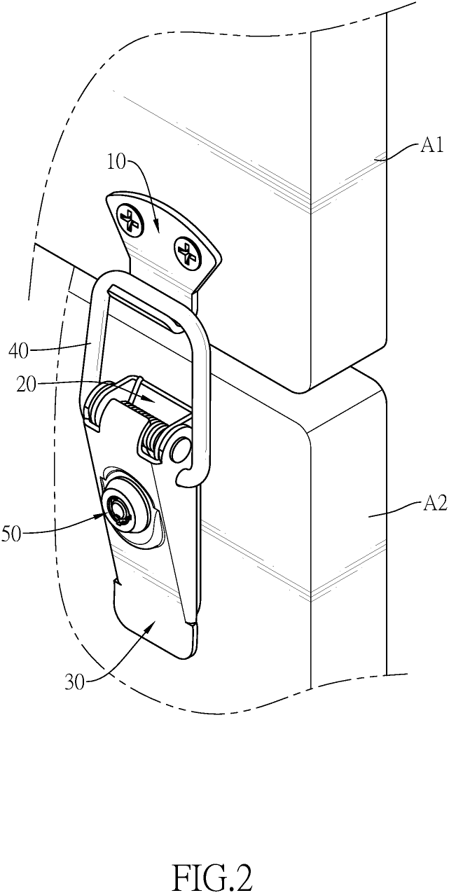

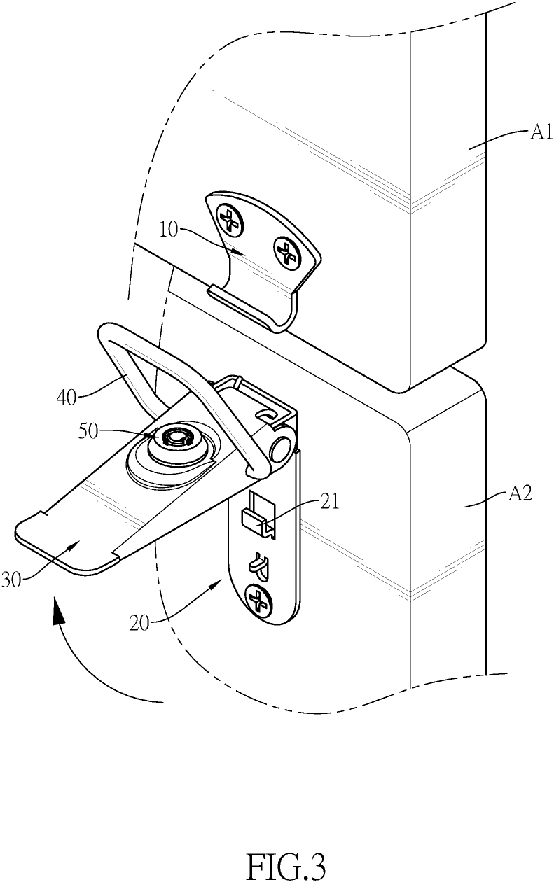

With reference to FIGS. 1, 2, and 3, a buckle lock assembly in accordance with the present invention is adapted to be mounted on a first locked unit A1 and a second locked unit A2, and is capable of locking the first locked unit A1 and the second locked unit A2. Specifically, the first locked unit A1 and the second locked unit A2 can respectively be a lid of a box and a box wall, or can respectively be a lid of a sealing can and a can wall.

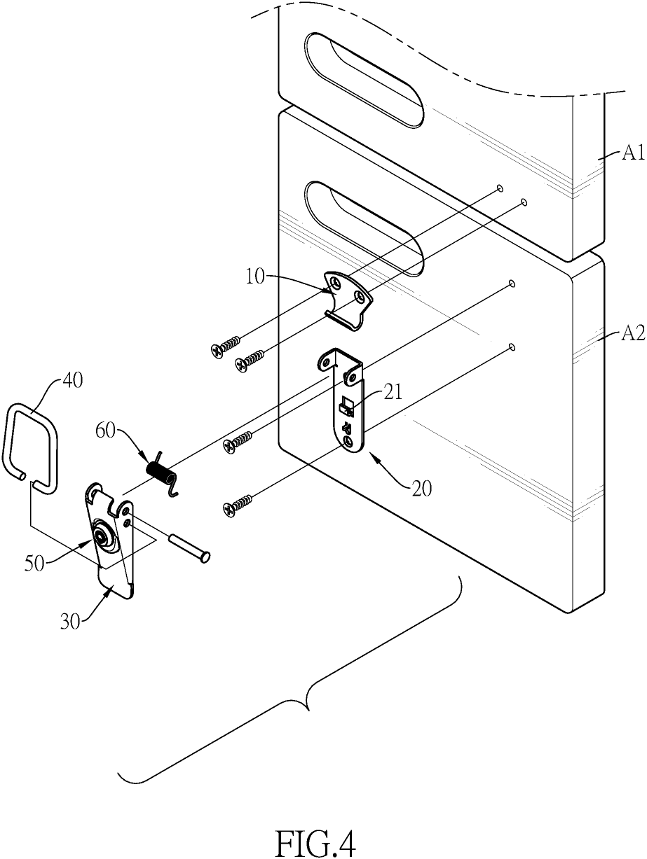

With reference to FIG. 4, the buckle lock assembly has a hook unit 10, a fixing base 20, a wrench unit 30, a buckling ring unit 40, a lock 50, and an elastic unit 60.

The hook unit 10 is adapted to be securely mounted on the first locked unit A1.

The fixing base 20 is adapted to be securely mounted on the second locked unit A2, and has a locking segment 21. In this embodiment, the locking segment 21 is a sheet, but the locking segment 21 can also be a ring or a hook in other embodiments.

With reference to FIGS. 4, 5, and 6, an end of the wrench unit 30 is pivotally mounted on the fixing base 20. The wrench unit 30 has an outer surface 31, an inner surface 32, and an assembling hole 33. In this embodiment, the outer surface 31 of the wrench unit 30 forms a convex segment 311. A portion on the inner surface 32 corresponding to the convex segment 311 forms a concave segment 321. The assembling hole 33 is formed on the convex segment 311 and communicates with the concave segment 321. In other words, a wall of the wrench unit 30 is uneven and protrudes forward to form the convex segment 311 and the concave segment 321, but the wrench unit 30 can also be implemented without the convex segment 311 and the concave segment 321 in other embodiments.

The buckling ring unit 40 is pivotally mounted on the wrench unit 30, and selectively clasps the hook unit 10. Specifically, in this embodiment, the buckling ring unit 40 is a ring in a C shape, and the two ends of the C are mounted on the wrench unit 30, but the buckling ring unit 40 can also be in an O shape in other embodiments.

The lock 50 is securely mounted on the wrench unit 30. When the lock 50 is in a locked state, the lock 50 engages with the locking segment 21 of the fixing base 20 to limit the wrench unit 30 pivoting relative to the fixing base 20 to lock the first locked unit A1 and the second locked unit A2. When the lock 50 is in an unlocked state, the lock 50 disengages from the locking segment 21 of the fixing base 20 to allow the wrench unit 30 to pivot relative to the fixing base 20.

Specifically, in this embodiment, the lock 50 is a tubular lock and has a lock base unit 51, a fixing unit 52, an axle segment 53, a buckling unit 54, a lock cylinder base 55, multiple first lock bolts 56, and multiple second lock bolts 57, but in other embodiments, the lock 50 can also be implemented as any other locks instead of a tubular lock.

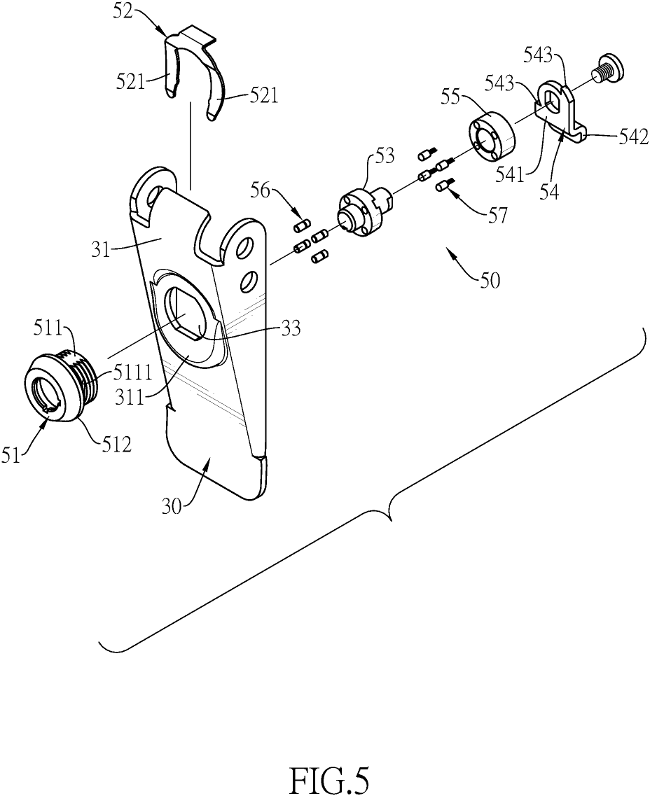

With reference to FIG. 5, the lock cylinder base 55 is mounted in the lock base unit 51 and is fixed with the lock base unit 51. The axle segment 53 is rotatably mounted in the lock cylinder base 55. The lock cylinder base 55 and the axle segment 53 respectively form multiple holes corresponding in position with each other. The first lock bolts 56 are respectively movably mounted in the holes formed on the axle segment 53. The second lock bolts 57 are respectively movably mounted in the holes formed on the lock cylinder base 55, and are pushed by springs to protrude out of the holes formed on the lock cylinder base 55 and to protrude into the holes formed on the axle segment 53.

Therefore, the second lock bolts 57 are mounted in both the holes formed on the lock cylinder base 55 and the holes formed on the axle segment 53 at the same time, such that the axle segment 53 cannot rotate relative to the lock cylinder base 55, which means the lock 50 is locked. The first lock bolts 56 and the second lock bolts 57 have different lengths. When a user inserts the corresponding key, the key first pushes the first lock bolts 56 with dents or bumps that match the lengths of the first lock bolts 56 and the second lock bolts 57, and then the key pushes the second lock bolts 57 via the first lock bolts 56 to make the second lock bolts 57 exactly detach from the holes formed on the axle segment 53 and to keep the first lock bolts 56 staying out of the holes formed on the lock cylinder base 55, so that the axle segment 53 is allowed to rotate relative to the lock cylinder base 55, which means the lock 50 is unlocked.

In this embodiment, an amount of the first lock bolts 56 and an amount of the second lock bolts 57 are both four, i.e., a four-bolt lock cylinder. But the amount of the first lock bolts 56 and the amount of the second lock bolts 57 can also be seven, i.e., a seven-bolt lock cylinder. In other words, the amount of the first lock bolts 56 and the amount of the second lock bolts 57 can be set as needed to improve the diversity of combinations and enhance the security of the lock 50.

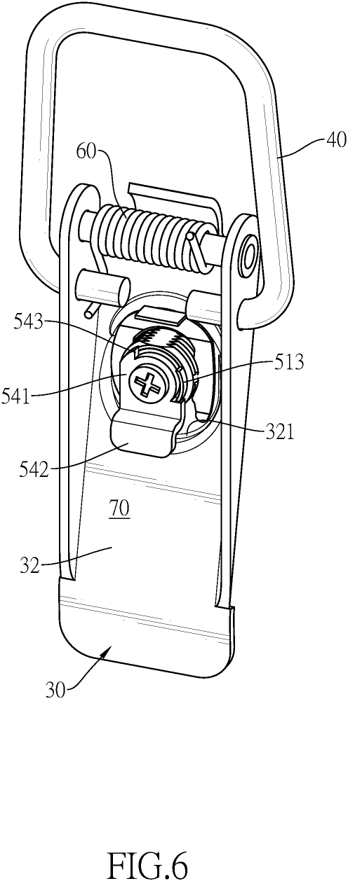

With reference to FIGS. 5 and 6, the lock base unit 51 has a tube segment 511, an annular flange 512, and a limiting segment 513. The tube segment 511 is mounted in the assembling hole 33 of the wrench unit 30. An outer annular surface of the tube segment 511 forms at least one annular groove 5111. The annular flange 512 is formed on an end of the tube segment 511, protrudes out along a radial direction of the tube segment 511, and abuts the outer surface 31 of the wrench unit 30. In this embodiment, the annular flange 512 abuts the convex segment 311. The limiting segment 513 is formed on the other end of the tube segment 511 opposite to the annular flange 512.

The fixing unit 52 engages with one of the at least one annular groove 5111 of the tube segment 511, and abuts the inner surface 32 of the wrench unit 30 to fix the lock base unit 51 on the wrench unit 30. Specifically, in this embodiment, the fixing unit 52 is located inside the concave segment 321 of the wrench unit 30. Additionally, the fixing unit 52 is a sheet in a C shape, is formed like a fork, and has two fixing sheet segments 521. The two fixing sheet segments 521 engage in said one of the at least one annular groove 5111, and are respectively located in two opposite sides of the tube segment 511, which means the fixing unit 52 crosses and clamps the tube segment 511 like a fork.

The aforementioned structure of the fixing unit 52 is not limited thereto, as the fixing unit 52 can be implemented in any form instead of a C shape fork sheet, and the fixing unit 52 can also be implemented without the fixing sheet segments 521. In such embodiment, the fixing unit 52 can be implemented as a ring mounted around the tube segment 511, engaging in the annular groove 5111, and abutting the inner surface 32 of the wrench unit 30, such that the fixing unit 52 is still capable of fixing the lock base unit 51 on the wrench unit 30. Further, in other embodiments, the lock 50 can also be implemented without the fixing unit 52, as the lock base unit 51 can be directly welded on the wrench unit 30.

The axle segment 53 is rotatably mounted in the tube segment 511 of the lock base unit 51.

The buckling unit 54 has a main body 541, a buckling segment 542, and two stopping segments 543.

The main body 541 is securely mounted on the axle segment 53, and rotates along with the axle segment 53. The limiting segment 513 of the lock base unit 51 is located in an outer side in a radial direction of the main body 541 of the buckling unit 54.

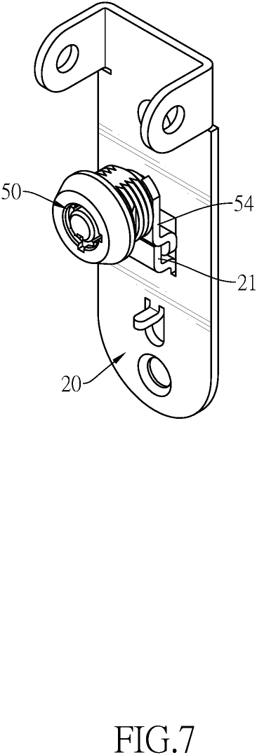

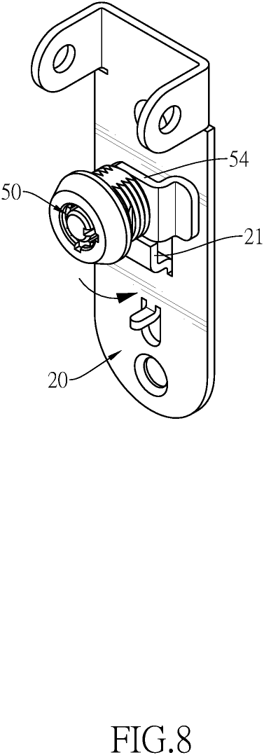

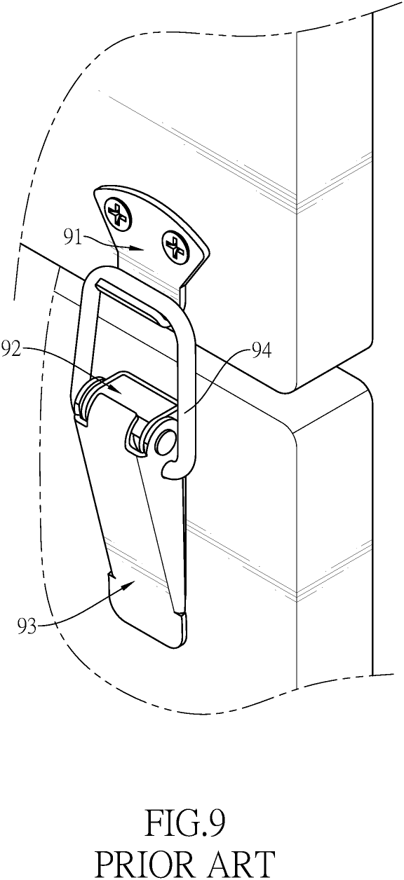

With reference to FIGS. 7 and 8, the buckling segment 542 is connected to an edge of the main body 541, and extends outward along a radial direction of the axle segment 53. The buckling segment 542 moves relative to the locking segment 21 of the fixing base 20 along with the rotation of the axle segment 53. When the lock 50 is in the locked state, the buckling segment 542 moves along with the main body 541 to engage with the locking segment 21 to limit the wrench unit 30 pivoting relative to the fixing base 20. When the lock 50 is in the unlocked state, the buckling segment 542 moves along with the main body 541 to disengage from the locking segment 21 to allow the wrench unit 30 to pivot relative to the fixing base 20.

Specifically, in this embodiment, the buckling segment 542 is a sheet as well as the locking segment 21. When the lock 50 is in the locked state, the buckling segment 542 moves to the locking segment 21 located between the buckling segment 542 and the wrench unit 30, such that the buckling segment 542 engages with the locking segment 21. But in other embodiments, the buckling segment 542 can also be implemented as a hook or a ring that matches with the locking segment 21.

Two stopping segments 543 are formed on the edge of the main body 541. When the buckling unit 54 rotates, the buckling unit 54 is capable of abutting the limiting segment 513 with one of the two stopping segments 543 to be stopped by the limiting segment 513 from further rotating. But in other embodiments, the aforementioned structure that limits the rotation is not limited thereto, as the structure that limits the rotation can be implemented as a groove and a rod cooperating with each other.

Additionally, with reference to FIGS. 4 and 6, in this embodiment, an accommodating space 70 is formed between the wrench unit 30 and the fixing base 20. After the wrench unit 30 is pulled to clasp the hook unit 10, the wrench unit 30 covers and encloses the accommodating space 70, and the locking segment 21 and the buckling segment 542 are located in the accommodating space 70, thereby preventing the locking segment 21 and the buckling segment 542 from exposing outside the wrench unit 30 and preventing any unauthorized attempt to break the locking segment 21 and the buckling segment 542 to unlock.

The elastic unit 60 is configured to turn the wrench unit 30 toward the fixing base 20. Specifically, in this embodiment, the elastic unit 60 is a torsion spring. An end of the torsion spring abuts the buckling ring unit 40, and another end of the torsion spring abuts the fixing base 20. But in other embodiments, the elastic unit 60 can be implemented as an extension spring, or the buckle lock assembly can also be implemented without the elastic unit 60.

By securely mounting the lock 50 on the wrench unit 30 and forming the locking segment 21 on the fixing base 20, after the buckling ring unit 40 clasps the hook unit 10 and is pulled by the wrench unit 30 to buckle, a user can switch the lock 50 to the locked state and make the lock 50 engage with the locking segment 21 of the fixing base 20 to limit the wrench unit 30 pivoting relative to the fixing base 20 again. Eventually, the first locked unit A1 and the second locked unit A2 are locked with each other, and therefore the buckle lock assembly has an anti-theft function. Further, since the locking segment 21 and the buckling segment 542 are located in the accommodating space 70 and are enclosed by the wrench unit 30, the buckle lock assembly cannot be easily broken from outside.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

1. A buckle lock assembly adapted to be mounted on a first locked unit and a second locked unit, and being capable of locking the first locked unit and the second locked unit; the buckle lock assembly comprising:
a hook unit adapted to be securely mounted on the first locked unit;
a fixing base adapted to be securely mounted on the second locked unit and having
a locking segment;
a wrench unit pivotally mounted on the fixing base;
a buckling ring unit pivotally mounted on the wrench unit and selectively clasping the hook unit; and
a lock securely mounted on the wrench unit; the lock being a tubular lock and having:
a lock base unit fixed on the wrench unit;
a lock cylinder base mounted in the lock base unit and fixed with the lock base unit;
an axle segment rotatably mounted in the lock cylinder base; the lock cylinder base and the axle segment each form multiple holes corresponding in position with each other;
a buckling unit mounted on the axle segment and rotating along with the axle segment;
multiple second lock bolts respectively movably mounted in the holes formed on the lock cylinder base, and pushed by springs to protrude out of the holes formed on the lock cylinder base and to protrude into the holes formed on the axle segment, thereby preventing the axle segment from rotating relative to the lock cylinder base; when a corresponding key is inserted, the second lock bolts configured to be pushed by the key such that the second lock bolts detach from the holes formed on the axle segment, thereby allowing the axle segment to rotate relative to the lock cylinder base;
wherein
when the lock is in a locked state, the buckling unit of the lock engages with the locking segment of the fixing base to limit the wrench unit pivoting relative to the fixing base to lock the first locked unit and the second locked unit; and
when the lock is in an unlocked state, the buckling unit of the lock disengages from the locking segment of the fixing base to allow the wrench unit to pivot relative to the fixing base.

2. The buckle lock assembly as claimed in claim 1, wherein
the wrench unit has
an outer surface;
an inner surface; and
an assembling hole; and
the lock base unit of the lock has
a tube segment mounted in the assembling hole of the wrench unit; an outer annular surface of the tube segment forming at least one annular groove;
an annular flange protruding out along a radial direction of the tube segment and abutting the outer surface of the wrench unit;
the lock has
a fixing unit engaging in one of the least one annular groove and abutting the inner surface of the wrench unit to fix the lock base unit on the wrench unit.

3. The buckle lock assembly as claimed in claim 2, wherein the fixing unit has
two fixing sheet segments engaging in said one of the least one annular groove and respectively located in two opposite sides of the tube segment.

4. The buckle lock assembly as claimed in claim 2, wherein
the outer surface of the wrench unit forms a convex segment;
a portion on the inner surface corresponding to the convex segment forms a concave segment;
the assembling hole is formed on the convex segment and communicates with the concave segment;
the annular flange of the lock base unit abuts the convex segment; and
the fixing unit is located in the concave segment.

5. The buckle lock assembly as claimed in claim 3, wherein
the outer surface of the wrench unit forms a convex segment;
a portion on the inner surface corresponding to the convex segment forms a concave segment;
the assembling hole is formed on the convex segment and communicates with the concave segment;
the annular flange of the lock base unit abuts the convex segment; and
the fixing unit is located in the concave segment.

6. The buckle lock assembly as claimed in claim 1, wherein the buckling unit of the lock has
a main body securely mounted on the axle segment and rotating along with the axle segment; and
a buckling segment connected to an edge of the main body and extending outward along a radial direction of the axle segment; the buckling segment moving relative to the locking segment of the fixing base along with the rotation of the axle segment;
wherein when the lock is in the locked state, the buckling segment moves along with the main body to engage with the locking segment to limit the wrench unit pivoting relative to the fixing base;
wherein when the lock is in the unlocked state, the buckling segment moves along with the main body to disengage from the locking segment to allow the wrench unit to pivot relative to the fixing base.

7. The buckle lock assembly as claimed in claim 5, wherein the buckling unit of the lock has
a main body securely mounted on the axle segment and rotating along with the axle segment; and
a buckling segment connected to an edge of the main body and extending outward along a radial direction of the axle segment; the buckling segment moving relative to the locking segment of the fixing base along with the rotation of the axle segment;
wherein when the lock is in the locked state, the buckling segment moves along with the main body to engage with the locking segment to limit the wrench unit pivoting relative to the fixing base;
wherein when the lock is in the unlocked state, the buckling segment moves along with the main body to disengage from the locking segment to allow the wrench unit to pivot relative to the fixing base.

8. The buckle lock assembly as claimed in claim 6, wherein
the locking segment is a sheet;
the buckling segment is a sheet; and
when the lock is in the locked state, the locking segment is located between the buckling segment and the wrench unit such that the buckling segment engages with the locking segment.

9. The buckle lock assembly as claimed in claim 7, wherein
the locking segment is a sheet;
the buckling segment is a sheet; and
when the lock is in the locked state, the locking segment is located between the buckling segment and the wrench unit such that the buckling segment engages with the locking segment.

10. The buckle lock assembly as claimed in claim 6, wherein
an accommodating space is formed between the wrench unit and the fixing base; and
the locking segment and the buckling segment are located in the accommodating space.

11. The buckle lock assembly as claimed in claim 9, wherein
an accommodating space is formed between the wrench unit and the fixing base; and
the locking segment and the buckling segment are located in the accommodating space.

12. The buckle lock assembly as claimed in claim 6, wherein
the lock has
a limiting segment located in an outer side in a radial direction of the main body of the buckling unit;
the buckling unit has
two stopping segments formed on an edge of the main body; and
when the buckling unit rotates, the buckling unit is capable of abutting the limiting segment with one of the two stopping segments to be stopped by the limiting segment from further rotating.

13. The buckle lock assembly as claimed in claim 11, wherein
the lock has
a limiting segment located in an outer side in a radial direction of the main body of the buckling unit;
the buckling unit has
two stopping segments formed on the edge of the main body; and
when the buckling unit rotates, the buckling unit is capable of abutting the limiting segment with one of the two stopping segments to be stopped by the limiting segment from further rotating.

14. The buckle lock assembly as claimed in claim 1, wherein the buckle lock assembly has
an elastic unit configured to turn the wrench unit toward the fixing base.

15. The buckle lock assembly as claimed in claim 13, wherein the buckle lock assembly has
an elastic unit configured to turn the wrench unit toward the fixing base.

16. The buckle lock assembly as claimed in claim 14, wherein the elastic unit is a torsion spring.

17. The buckle lock assembly as claimed in claim 15, wherein the elastic unit is a torsion spring.

18. The buckle lock assembly as claimed in claim 16, wherein an end of the torsion spring abuts the buckling ring unit, and another end of the torsion spring abuts the fixing base.

19. The buckle lock assembly as claimed in claim 17, wherein an end of the torsion spring abuts the buckling ring unit, and another end of the torsion spring abuts the fixing base.

20. (canceled)
